(19) United States
(12) Patent Application Publication
(10) Pub. No.: US 2019/0153823 A1
(43) Pub. Date: May 23, 2019

(54) PROCESS AND EQUIPMENT OF FOSSIL FUEL POWER GENERATION WITH ZERO CARBON EMISSION

(71) Applicant: Sigan Peng, (US)

(72) Inventor: Sigan Peng, Wuhan (CN)

(21) Appl. No.: 16/079,179

(22) PCT Filed: Apr. 19, 2016
(86) PCT No.: PCT/CN2016/079626

§ 371 Date: Aug. 23, 2018

(30) Foreign Application Priority Data
Feb. 23, 2016 (CN) 201610098296.4

(51) Int. Cl. E21B 43/00; F01D 15/10; F02C 3/22; E21B 41/00

(52) U.S. Cl. CPC E21B 43/00; F01D 15/10; H01H 71/16; E21B 41/0064; F02C 3/22

(57) ABSTRACT

The present invention relates to a process and an equipment of fossil fuel power generation with zero carbon emission, and provides the following complete technical solution of carbon capture and storage (CCS). Power generation of oxygen enriched combustion of fossil fuel such as coal is carried out in a power plant on a carbon dioxide storage site. The generated flue gas of carbon dioxide is pressurized and injected into the saline aquifer of the carbon storage site and/or an oil/gas field in situ. The generated power is transmitted externally. The present invention has the following technical advantages. The transportation step in existing CCS technology is eliminated, namely, the whole process of carbon loading and long-distance transportation and then unloading included in the transportation step is eliminated, which greatly reduces the difficulty and cost of implementing the complete CCS technical solution, and improves the feasibility of the CCS technical solution. It is helpful for the large-scale implementation of carbon capture and storage in the course of power generation using fossil fuels such as coal, namely, fossil fuel power generation with zero carbon emission. In this way, a new technical route is provided to break through CCS predicament, and large-scale comprehensive utilization of fossil energy resources such as a large number of coal/oil-gas and geological resources of a large number of saline aquifers can be realized finally.

### CROSS-REFERENCE TO RELATED APPLICATIONS

This application is the U.S. national stage of PCT/CN2016/079626 filed Apr. 19, 2016, which claims priority of Chinese Patent Application 201610098296.4 filed Feb. 23, 2016 of which is hereby incorporated by reference in its entirety.

### FIELD OF THE INVENTION

The present invention relates to a process and an equipment of fossil fuel power generation with zero carbon emission, belonging to a technical field of clean energy. The present invention especially relates to a technical solution (technical route) of carbon capture and storage (CCS).

### DESCRIPTION OF RELATED ART

Carbon emissions of fossil fuel cause climate deterioration. However, it is unrealistic to abandon a large number of fossil energy resources. Therefore, the early realization of carbon capture and storage (CCS) of fossil fuels is the only way to develop the economy and prevent the climate catastrophe and to achieve the 2° C. (2DS) climate target. On the other hand, people have also developed a large number of geological resources suitable for long-term carbon storage, such as oil-gas reservoirs, coal reservoirs and saline aquifers and so on. There are many existing forms and projects on expected CCS technical solution of comprehensive utilization of fossil energy and carbon storage resources. As shown in FIG. 4, FIG. 5 and FIG. 6, all of them comprise three steps including carbon capture, transportation and sequestration. In the step of carbon capture, there are unit technologies such as oxygen enriched combustion, chemical extraction, membrane separation, capture before combustion currently. In the step of sequestration, the technologies of exploring storage resources and safety assessment are developed mainly. In the step of transportation, there are the technologies of construction and operation of the supercritical pipeline net and others mainly. It is generally believed that the unit technologies of CCS are not complex, but it is very difficult to integrate all the units into a complete (whole process) technical solution. Therefore, the advance of complete CCS technical solution has been slow for many years, and the expectation of combining the fossil energy and carbon storage resources indeed has not been achieved up to now. The carbon capture and storage of large scale cannot function. As a result, even the in-progress projects of experimental demonstration that have been widely questioned and negated all round the world in recent years have been closed down. However, even in such technological predicament of CCS, people have not abandoned the desire and pursuit to CCS. Instead, they constantly call for the development of new CCS technical solutions.

### SUMMARY OF THE INVENTION

In order to overcome the technical deficiency causing current CCS predicament, the present invention provides a process and an equipment of fossil fuel power generation with zero carbon emission, which is also a new complete CCS technical solution. The fossil fuel described in the present invention includes one or a combination of coal, oil, natural gas, coalbed gas and flammable ice. The zero carbon emission refers to that CCS is realized for most or all of the carbon dioxide generated in the course of fossil fuel power generation. The purpose of the present invention is to eliminate the transportation step of existing CCS technology, namely, to eliminate the whole process of carbon loading and long-distance transportation and then unloading included in the transportation step, which greatly reduces the difficulty and cost of implementing the complete CCS technical solution, and improves the feasibility of the CCS technical solution. It is helpful for the large-scale implementation of carbon capture and storage in the course of power generation using fossil fuels such as coal, namely, fossil fuel power generation with zero carbon emission. Therefore, a new technical route is provided to break through CCS predicament, and large-scale comprehensive utilization of a large number of fossil energy resources such as coal/oil-gas and a large number of geological resources of saline aquifer can be realized finally.

The technical solution of the process of fossil fuel power generation with zero carbon emission is set forth as below.

A process of fossil fuel power generation with zero carbon emission comprises the steps of:

carrying out power generation of oxygen enriched combustion of fossil fuel in a power plant on a carbon dioxide storage site;

pressurizing and injecting the generated flue gas of carbon dioxide into the carbon storage site in situ to sequestrate the carbon dioxide; and

transmitting the generated power externally;

wherein the oxygen enriched combustion refers to a combustion that oxygen gas is blown in the course of burning to increase the concentration of carbon dioxide in the flue gas.

Preferred embodiments are provided as below.

In the process of fossil fuel power generation with zero carbon emission, the step of pressurizing and injecting the flue gas of carbon dioxide into the carbon storage site in situ refers to pressurizing and injecting the carbon dioxide generated in the course of power generation into the carbon storage site directly, and the step of pressurizing and injecting into the carbon storage site directly refers to that the horizontal distance between the site of generating the flue gas of carbon dioxide and the site of injecting is near zero.

In the process of fossil fuel power generation with zero carbon emission, the flue gas of carbon dioxide is pressurized and injected into the carbon storage site through anticorrosive facilities and pipelines.

In the process of fossil fuel power generation with zero carbon emission, the carbon storage site is a saline aquifer of carbon storage site, which is a site having underground geological structure of saline aquifer suitable for storage of carbon dioxide, and the flue gas of carbon dioxide is pressurized and injected into the saline aquifer of carbon storage site in situ.

In the process of fossil fuel power generation with zero carbon emission, water and/or air are used as a cooling medium in the power plant.

In the process of fossil fuel power generation with zero carbon emission, the step of transmitting the generated power externally refers to transmitting the power from the power plant to an external power grid, comprising transmitting the power to a national grid, an international grid, or an intercontinental power grid, and/or a factory which is set up near the power plant through power cables.

The technical solution of an equipment of fossil fuel power generation with zero carbon emission for carrying out the process of the present invention is set forth as below.

It comprises an oxygen enriched combustion and dynamic device, wherein a fossil fuel providing device, a power generating and transforming device, a cooling device, an air separation and oxygen making device and a gas storing device for cleaning and pressurizing flue gas of carbon dioxide are connected to the oxygen enriched combustion and dynamic device, and the gas storing device for cleaning and pressurizing flue gas of carbon dioxide is connected to a top of a carbon dioxide injecting wells, and an end of the carbon dioxide injecting wells is communicated with the saline aquifer of carbon storage site.

Preferred embodiments are provided as below.

In the equipment of fossil fuel power generation with zero carbon emission, the gas storing device for cleaning and pressurizing flue gas of carbon dioxide and the carbon dioxide injecting wells are made of anticorrosive materials.

In the equipment of fossil fuel power generation with zero carbon emission, the cooling device includes a cooling water pump and/or a cooling fan.

Combined with the technical principle of the present invention, the technical solution and effects of the present invention are set forth as below.

The technical principle of the present invention is set forth as follows. In some areas, there are geological structures such as saline aquifer that are suitable for long-term storage of a large amount of carbon. The oxygen enriched combustion of fossil fuel is used to generate power on these carbon dioxide storage sites. Oxygen gas is blown in the course of burning, so that the flue gas generated in the course of burning directly becomes the flue gas of high concentrated carbon dioxide. Then it is pressurized and injected into the carbon storage site. In this way, the carbon capture and storage with low cost is realized. In the technical solution of the present invention, because the existing transportation step of high risk between the step of carbon capture and step of carbon sequestration is eliminated, not only is the whole process of carbon loading and long-distance transportation and then unloading included in transportation step eliminated, but also commercial technical requirements that carbon dioxide should be captured to a strict product of high purity, high pressure and supercritical liquefied status in the transportation step is no longer needed. The technical principle of the present invention is characterized by being suitable to local conditions and eliminating necessary element.

The technical effects of the present invention are set forth as follows. The difficulty and cost of implementing the complete CCS technical solution are reduced. The feasibility of implementing the CCS in large scale is improved. For the projects of experimental demonstration of CCS technology, the cycle can be shortened and the investment barrier can be lowered, thus the fossil fuels such as coal and oil acceleratingly become clean energy with zero carbon emission, and a new technical route is provided to break through CCS predicament.

### BRIEF DESCRIPTION OF THE DRAWINGS

FIG. 1 is a schematic diagram showing the procedure of an example of the process of fossil fuel power generation with zero carbon emission of the present invention, and is also a schematic diagram showing CCS technical route of the present invention. The process of the present example comprises the steps of carrying out power generation of oxygen enriched combustion of fossil fuel on a carbon storage site and pressurizing and injecting the generated flue gas of carbon dioxide into the carbon storage site in situ.

FIG. 2 is a schematic diagram showing an example of the equipment of fossil fuel power generation with zero carbon emission of the present invention. In the present example, the gas storing device 6 for cleaning and pressurizing flue gas of carbon dioxide is connected to a top of a carbon dioxide injecting wells 7, and an end of the carbon dioxide injecting wells 7 is communicated with the saline aquifer 8 of carbon storage site.

FIG. 3 is a schematic diagram showing another example of the process of fossil fuel power generation with zero carbon emission of the present invention. The process of the present example comprises the steps of carrying out power generation of oxygen enriched combustion of coal on a carbon storage site and pressurizing and injecting the generated flue gas of carbon dioxide into the carbon storage site in situ.

FIG. 4 is a schematic diagram showing an existing CCS technical solution of power generation of oxygen enriched combustion of coal.

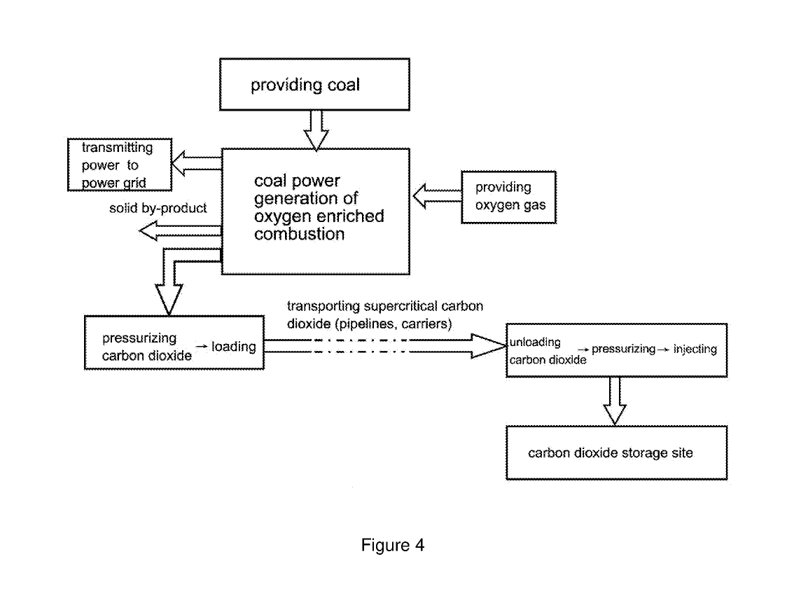

FIG. 5 is a schematic diagram showing an existing CCS technical solution of coal power generation.

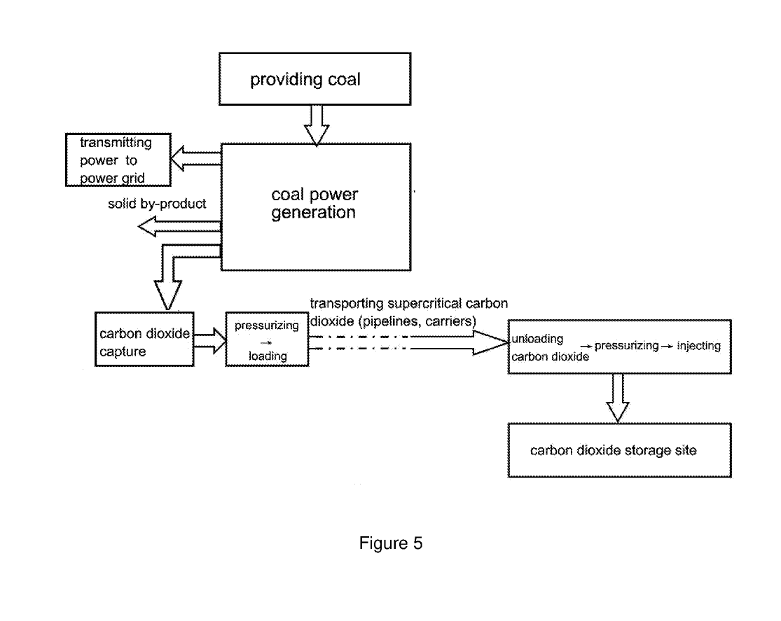

FIG. 6 is a schematic diagram showing an existing CCS technical solution of oil/gas power generation.

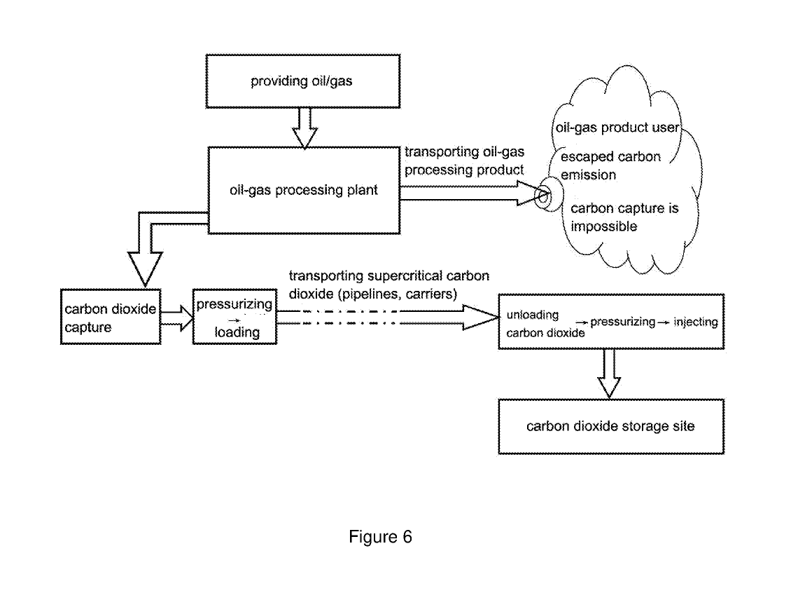

In these figures, 1—oxygen enriched combustion and dynamic device, 2—fossil fuel providing device, 2.1—fossil fuel (coal/oil/gas), 3—power generating and transforming device, 3.1—transmitting power to power grid through power cables, 4—cooling device, 4.1—cooling medium (water/air), 5—air separation and oxygen making device, 5.1—air, 5.2—nitrogen gas, 6—gas storing device for cleaning and pressurizing flue gas of carbon dioxide, 6.1—solid by-product, 7—injecting carbon dioxide into wells, 8—saline aquifer of carbon storage site

### DETAILED DESCRIPTION OF THE PREFERRED EMBODIMENTS

Combined with the figures and examples, the further description on the process and an equipment of fossil fuel power generation with zero carbon emission of the present invention is provided as below.

### EXAMPLE 1

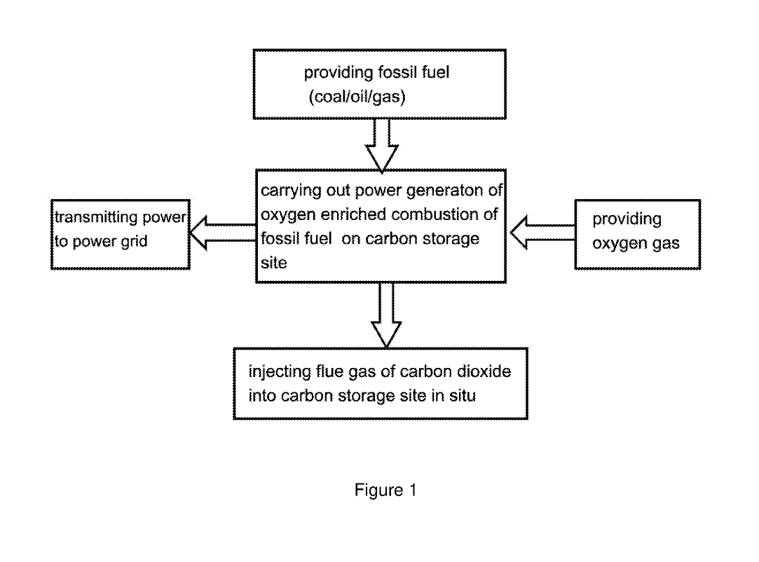

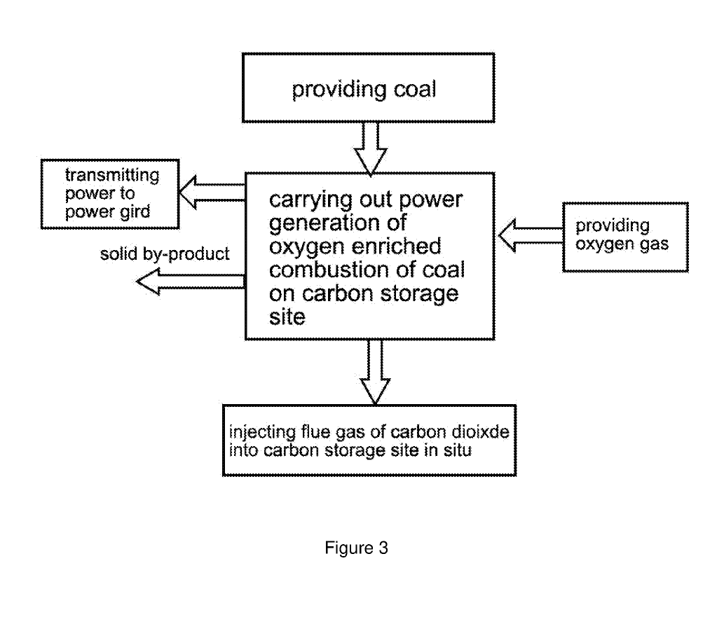

This is a basic example of the process of fossil fuel power generation with zero carbon emission of the present invention. As shown in FIGS. 1 and 3, the process of fossil fuel power generation with zero carbon emission comprises the steps of:

carrying out power generation of oxygen enriched combustion of fossil fuel in a power plant on a carbon dioxide storage site;

pressurizing and injecting the generated flue gas of carbon dioxide into the carbon storage site in situ to sequestrate the carbon dioxide; and

transmitting the generated power externally;

wherein the oxygen enriched combustion refers to a combustion that oxygen gas is blown in the course of burning to increase the concentration of carbon dioxide in the flue gas.

### EXAMPLE 2

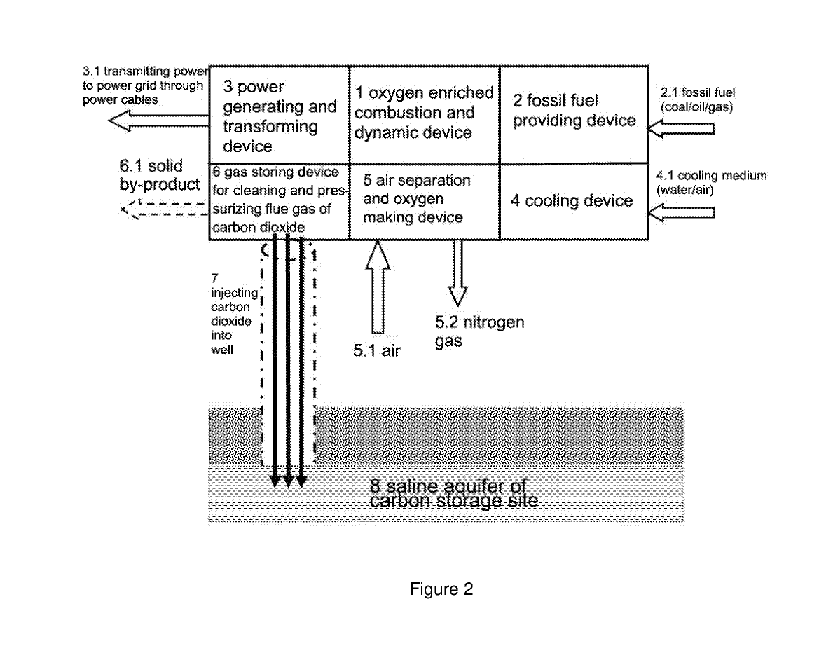

This is a further example based on Example 1. As shown in FIG. 2, the step of pressurizing and injecting the flue gas of carbon dioxide into the carbon storage site in situ refers to pressurizing and injecting the carbon dioxide generated in the course of power generation into the carbon storage site directly, and the step of pressurizing and injecting into the carbon storage site directly refers to that the horizontal distance between the site of generating the flue gas of carbon dioxide and the site of injecting is near zero.

The horizontal distance between the site of generating flue gas of carbon dioxide (source) and the site of injecting (sink) is less than 20 km, and is less than 1/10 of source-sink distance in existing CCS technical solution which is usually about 200 km. The carbon dioxide generated in the course of power generation is pressurized and injected into the carbon storage site directly. The transportation step between the carbon capture step and the carbon sequestration step in existing CCS technology is eliminated, so that the whole process of carbon loading, unloading and long-distance transportation included in the transportation step is eliminated.

The oxygen enriched combustion is a kind of low-cost prior art to make flue gas of fossil fuel being one of high concentration of carbon dioxide.

### EXAMPLE 3

This is a further example based Example 1. The flue gas of carbon dioxide is pressurized and injected into the carbon storage site through anticorrosive facilities and pipelines.

In view of that the flue gas of fossil fuel contains corrosive gases such as carbon dioxide and sulfur dioxide, the pipeline facilities for pressurizing and injecting the flue gas are made of qualified anticorrosive technical materials with reliability and safety.

### EXAMPLE 4

This is a further example based on Example 1. The carbon storage site is a saline aquifer of carbon storage site, which is a site having underground geological structure of saline aquifer suitable for the storage of carbon dioxide, and the flue gas of carbon dioxide generated in the course of fossil fuel power generation is pressurized and injected into the saline aquifer of carbon storage site in situ to sequestrate the carbon dioxide.

In the present example, the coal power plant is built on a site having underground geological structure of saline aquifer, which has the following advantages. The carbon storage capability of a large number of saline aquifers has been ascertained in the area, which is several dozen times of storage capability of the oil-gas field ascertained in the area, so that the requirement of carbon capture and storage for long-term power generation of a large coal power plant can be met.

Water and/or air are used as cooling medium in the power plant, and fresh water and/or salt water can be used as cooling water.

In order to meet the cooling requirements for combustion and dynamic device such as steam turbine in the course of combustion and power generation, a cooling process comprising recirculating water cooling and air cooling is adopted in the present example.

The required cooling water is taken from the saline aquifer under the power plant.

### EXAMPLE 5

This is a further example based on Example 1. The step of transmitting the generated power externally refers to transmitting the power from power plant to external power grid, which comprises transmitting the power to a national grid, an international grid, or an intercontinental power grid, and/or a factory which is set up near the power plant through power cables.

In one example, the power is only transmitted to nearby factory. In this way, the carbon dioxide generated in the factory can be injected into the carbon storage site in situ after combined with the flue gas containing carbon generated in the course of combustion and power generation.

### EXAMPLE 6

This is a basic example of the equipment of fossil fuel power generation with zero carbon emission of the present invention. The equipment of fossil fuel power generation with zero carbon emission as shown in FIG. 2 comprises an oxygen enriched combustion and dynamic device 1, wherein a fossil fuel providing device 2, a power generating and transforming device 3, a cooling device 4, an air separation and oxygen making device 5 and a gas storing device 6 for cleaning and pressurizing flue gas of carbon dioxide are connected to the oxygen enriched combustion and dynamic device 1, and the gas storing device 6 for cleaning and pressurizing flue gas of carbon dioxide is connected to a top of a carbon dioxide injecting wells 7, and an end of the carbon dioxide injecting wells 7 is communicated with the saline aquifer 8 of carbon storage site.

Regarding connection and communication of the present example, conventional parts such as flanges and valves are provided in the path of connection and communication according to the requirements of industrial process specification.

### EXAMPLE 7

This is a further example based on Example 6. In the equipment of fossil fuel power generation with zero carbon emission, the gas storing device 6 for cleaning and pressurizing flue gas of carbon dioxide and the carbon dioxide injecting wells 7 are made of anticorrosive materials.

In the equipment of fossil fuel power generation with zero carbon emission, the cooling device 4 includes a cooling water pump and/or a cooling fan.

Recirculating cooling water and air cooling device are adopted in the present example. The salty water in the saline aquifer under the power plant is taken as the supplemental water for the recirculating cooling water.

The horizontal distance between the site of generating flue gas of carbon dioxide (source) and the site of injecting (sink) in the present example is less than 2 km, and is less than 1/100 of source-sink distance in existing CCS technical solution which is usually about 200 km.

### EXAMPLE 8

This is a further example based on Example 7. In the present example, a new coal power plant is built on the site over a large area of saline aquifer. The flue gas of carbon dioxide generated in the course of power generation is pressurized and injected into the saline aquifer of the carbon storage site in situ to sequestrate the carbon dioxide. Group of coal generator units of oxygen enriched combustion, which is composed of 10 medium (300 MW) units, is configured in the coal power plant. Such configuration is suitable for the large-area distribution of saline aquifer. Moreover, in this way, the gas storing device 6 for cleaning and pressurizing flue gas of carbon dioxide can be right over the connected carbon dioxide injecting wells 7, so that the horizontal distance between the site of generating flue gas of carbon dioxide (source) and the site of injecting (sink) in the present example is zero.

Oxygen enriched combustion is adopted in the present example. The total heat energy efficiency of small and medium generator units can be equal to that of ordinary large ones. On the other hand, in such configuration, some coal transporting facilities, such as railway and feeder should be comprised. However, in general, compared with the transportation of high pressure and supercritical carbon dioxide, the transportation of fossil fuels, such as coal, oil and natural gas, is more mature, safer and lower-cost. The power plant generates about 20 billion degrees of clean power for the power grid every year without carbon emission. The main by-products of coal power generation are fly ash, which can be used as building material, soil amendment or landfill.

### EXAMPLE 9

This is a further example based on Example 7. In the present example, a new oil-gas power plant of oxygen enriched combustion is built on the site over a large area of saline aquifer. The flue gas of carbon dioxide generated in the course of power generation is pressurized and injected into the saline aquifer of the carbon storage site in situ to sequestrate the carbon dioxide. Fuels for power generation are mainly introduced from other high-yielding oil-gas fields through oil and gas pipelines. The gas storing device 6 for cleaning and pressurizing flue gas of carbon dioxide in the present example is right over the connected carbon dioxide injecting wells 7, and the horizontal distance between the site of generating flue gas of carbon dioxide (source) and the site of injecting (sink) in the present example is zero.

In the present example, the power plant comprises a group of generator units composed of 50 small (100 MW) units. Such configuration is suitable for the large area distribution of saline aquifer. Some oil-gas pipeline net should be built correspondingly. However, it is more mature, safer, lower-cost than building high pressure and supercritical carbon dioxide pipeline net.

### EXAMPLE 10

In the present example, a new oil-gas power plant of oxygen enriched combustion is built on a site over an exhausted oil field. The flue gas of carbon dioxide generated in the course of power generation is pressurized and injected into the oil field which is used as the carbon storage site in situ. Fuels for power generation are mainly introduced from other high-yielding oil-gas fields through oil and gas pipelines. Part of the fuels for power generation is newly produced oil from the local exhausted oil field due to further flooding caused by injection of carbon dioxide.

The protection scope claimed by the claims of the present invention is not limited to the above examples.

1. A process of fossil fuel power generation with zero carbon emission, comprising the steps of:
carrying out power generation of oxygen enriched combustion of fossil fuel in a power plant on a carbon dioxide storage site;
pressurizing and injecting the generated flue gas of carbon dioxide into the carbon storage site in situ to sequestrate the carbon dioxide; and
transmitting the generated power externally;
wherein the oxygen enriched combustion refers to a combustion that oxygen gas is blown in the course of burning to increase the concentration of carbon dioxide in the flue gas.

2. The process of fossil fuel power generation with zero carbon emission according to claim 1, wherein the step of pressurizing and injecting the flue gas of carbon dioxide into the carbon storage site in situ refers to pressurizing and injecting the carbon dioxide generated in the course of power generation into the carbon storage site directly, and the step of pressurizing and injecting into the carbon storage site directly refers to that the horizontal distance between the site of generating the flue gas of carbon dioxide and the site of injecting is near zero.

3. The process of fossil fuel power generation with zero carbon emission according to claim 1, wherein the flue gas of carbon dioxide is pressurized and injected into the carbon storage site through anticorrosive facilities and pipelines.

4. The process of fossil fuel power generation with zero carbon emission according to claim 1, wherein the carbon storage site comprises a saline aquifer of carbon storage site and/or an oil/gas field, and the saline aquifer of carbon storage site is a site having underground geological structure of saline aquifer suitable for storage of carbon dioxide, and the flue gas of carbon dioxide is pressurized and injected into the saline aquifer of carbon storage site and/or the oil/gas field in situ.

5. The process of fossil fuel power generation with zero carbon emission according to claim 1, wherein water and/or air are used as a cooling medium in the power plant.

6. The process of fossil fuel power generation with zero carbon emission according to claim 1, wherein the step of transmitting the generated power externally refers to transmitting the power from the power plant to an external power grid, comprising transmitting the power to a national grid, an international grid, or an intercontinental power grid, and/or a factory which is set up near the power plant through power cables.

7. An equipment of fossil fuel power generation with zero carbon emission for carrying out the process of claim 1, comprising an oxygen enriched combustion and dynamic device, wherein a fossil fuel providing device, a power generating and transforming device, a cooling device, an air separation and oxygen making device and a gas storing device for cleaning and pressurizing flue gas of carbon dioxide are connected to the oxygen enriched combustion and dynamic device, and the gas storing device for cleaning and pressurizing flue gas of carbon dioxide is connected to a top of a carbon dioxide injecting wells, and an end of the carbon dioxide injecting wells is communicated with the saline aquifer of carbon storage site and/or the oil/gas field.

8. The equipment of fossil fuel power generation with zero carbon emission according to claim 7, wherein the gas storing device for cleaning and pressurizing flue gas of carbon dioxide and the carbon dioxide injecting wells are made of anticorrosive materials.

9. The equipment of fossil fuel power generation with zero carbon emission according to claim 7, wherein the cooling device includes a cooling water pump and/or a cooling fan.
